(19) United States
(12) Patent Application Publication
(10) Pub. No.: US 2026/0356644 A1
(43) Pub. Date: Nov. 12, 2026

(54) MOVABLE WORKING PLATFORM

(71) Applicant: U.S. Titan Manufacturing, LLC, Fort Morgan, CO (US)

(72) Inventors: Nikolay Essani, Grand Junction, CO (US); Jason Gary, Sterling, CO (US)

(73) Assignee: U.S. Titan Manufacturing, LLC, Fort Morgan, CO (US)

(21) Appl. No.: 19/673,577

(22) Filed: May 11, 2026

Related U.S. Application Data
(60) Provisional application No. 63/804,332, filed on May 12, 2025.

(51) Int. Cl. B66F 11/04; B66F 17/00

(52) U.S. Cl. CPC B66F 11/04; B66F 17/006

(57) ABSTRACT

A movable working platform is provided. The platform may support an operator using a workstation. The working platform may be raisable and lowerable to adjust to different scenarios. In various instances, the movable working platform is attachable to the ground or a floor and can then raise or lower a platform above the ground. The platform may include a workstation, such as a sink and or knife washing station for utilization in a processing plant. For instance, an animal meat processing plant may have multiple movable working platforms that can be raised or lowered to accommodate different operations and different operators.

### CROSS-REFERENCE TO RELATED APPLICATIONS

This patent application is a non-provisional application that claims priority to U.S. Provisional Patent App. No. 63/804,332 entitled “MOVABLE WORKING PLATFORM” filed May 12, 2025, which is incorporated by reference herein in its entirety.

### BACKGROUND

### 1. Field

The various aspects and embodiments described herein relate to platforms and more specifically, to movable platforms for operators working in industrial and agricultural settings.

### 2. Description of the Related Art

Operators in industrial and agricultural settings often must sit or stand at workstations. In various instances, workpieces pass by the workstations and the operator interacts with the workpiece from positions on platforms at the workstations. In one instance, a meat processing plant has a conveyor system that moves carcasses along a path. Along the path, different workstations are positioned where operators perform different tasks to prepare meat from the carcass for packaging. In various instances, other food preparation or different tasks occur from the workstations.

In many of these instances, different use cases, or in some instances, the processing of different items or types of carcasses necessitates that the platforms be adjusted to be a different elevations relative to a floor or the conveyor system. Conventional stands require significant disassembly and reassembly to change the elevation of the platform and correspondingly result in operating downtime as the stand is adjusted. Thus, a need exists for movable platform that can move to accommodate different heights or other dimensions, according to the disclosure herein.

### SUMMARY

A movable working platform system is provided. The system may include a movable platform supporting a workstation. The movable platform is movable in at least a first direction. The system may include a support subsystem. The support subsystem may have various aspects. For instance, the support subsystem may have an attachment base that is attachable to a floor. The support subsystem may include a guide structure extending in the first direction away from the attachment base. The support subsystem may include a lifting mechanism attached to at least one of the attachment base and the guide structure. The lifting mechanism selectively raises and lowers the movable platform along at least the first direction to change a position of the workstation along the guide structure extending in the first direction. The movable working platform system may include an orientation support structure. The orientation support structure may be attached to the movable platform. The orientation support structure may include a plurality of rollers spaced around the guide structure in a plane oriented so that the first direction passes through the plane defined by the plurality of rollers. The plurality of rollers are contactable to the guide structure to retain the movable platform in movable connection to the guide structure.

In various embodiments, one or more further aspects may also be included. For instance, the plurality of rollers may include a first roller and a second roller disposed on opposite sides of the guide structure.

The plurality of rollers may include a first roller and a second roller disposed on opposite sides of the guide structure as well as a third roller and a fourth roller disposed on opposite sides of the guide structure. The third roller is disposed on a same side of the guide structure as the first roller. The fourth roller is disposed on a same side of the guide structure as the second roller. The first roller and the third roller are spaced apart a first spacing distance in the first direction. The second roller and the fourth roller are spaced apart a second spacing distance in the first direction. In various instances, the first spacing distance and the second spacing distance are a same distance.

In various instances, the guide structure has a first end and a second end opposite the first end. The first end is attached to the attachment base. The second end cantilevers away from the attachment base. In various embodiments, the second end of the guide structure is not attached to anything. In various embodiments, the first direction is a vertical direction.

The lifting mechanism may have different features. For example, the lifting mechanism may have a hydraulic cylinder. The lifting mechanism may have a shaft. The hydraulic cylinder may selectably extend the shaft. The shaft may be attached to the movable platform to move the movable platform in the first direction. The movable platform may have a standing surface for standing on by a worker while operating the workstation.

A further example of a movable working platform system is provided. The system may include a movable platform. The system may include a guide structure. The system may include a lifting mechanism. The system may include a plurality of rollers. The movable platform may be movable in at least a first direction along a guide structure. The guide structure may extend vertically from a floor in the first direction. The system may include a lifting mechanism attached to the movable platform to lift the movable platform in the first direction along the guide structure. The system may include a plurality of rollers attached to the movable platform and spaced around at least a portion of the guide structure to retain the movable platform in movable attachment to the guide structure.

Other features may be included. For instance, the plurality of rollers may include a first roller and a second roller disposed on opposite sides of the guide structure. The plurality of rollers may include a third roller and a fourth roller disposed on opposite sides of the guide structure. The third roller is disposed on a same side of the guide structure as the first roller. The fourth roller is disposed on a same side of the guide structure as the second roller. The first roller and the third roller are spaced apart a first spacing distance in the first direction. The second roller and the fourth roller are spaced apart a second spacing distance in the first direction.

The first spacing distance and the second spacing distance may be a different distance. The first spacing distance and the second spacing distance may be a same distance. The guide structure has a first end and a second end opposite the first end. The first end is attached to an attachment base attachable to the floor. The second end cantilevers away from the attachment base. In various embodiments, second end of the guide structure is not attached to anything.

The lifting mechanism may have a hydraulic cylinder to selectably extend a shaft that is attached to the movable platform to move the movable platform in the first direction. The movable platform may be a standing surface for standing on by a worker while operating the workstation. The workstation may be a sink and knife washing station. The movable platform may include a safety railing to ameliorate fall risk of the worker while operating the workstation with the movable platform extended in the first direction away from the floor.

A method is provided. The method may be a method of operating a movable working platform system. In various instances, the method may include providing a movable platform supporting a workstation. The movable platform may be movable in at least a first direction. The method may include providing a support subsystem having an attachment base that is attachable to a floor. The support subsystem may include a guide structure extending in the first direction away from the attachment base. The support subsystem may include a lifting mechanism attached to at least one of the attachment base and the guide structure. The lifting mechanism selectively raises and lowers the movable platform along at least the first direction to change a position of the workstation along the guide structure extending in the first direction. The method may include providing an orientation support structure attached to the movable platform. The orientation support structure may include a plurality of rollers spaced around the guide structure in a plane oriented so that the first direction passes through the plane defined by the plurality of rollers. The plurality of rollers are contactable to the guide structure to retain the movable platform in movable connection to the guide structure. The method may include operating the lifting mechanism to raise the movable platform along at least the first direction. This may progressively raise the workstation to a progressively higher position along the guide structure. The method may include stopping the lifting mechanism to cease raising the movable platform. The ceasing may be at a desired elevation relative to the floor underlying the guide structure.

### BRIEF DESCRIPTION OF THE DRAWINGS

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIG. 1 illustrates a front view of a movable working platform system, in accordance with various embodiments;

FIG. 2 illustrates a rear view of a movable working platform system, in accordance with various embodiments;

FIG. 3 illustrates a rear view of a movable working platform system in an elevated position, in accordance with various embodiments;

FIG. 4 illustrates a detailed rear view of aspects of an orientation support structure and a lifting mechanism of a movable working platform system, in accordance with various embodiments;

FIG. 5 illustrates a detailed side view of aspects of an orientation support structure of a movable working platform system, in accordance with various embodiments;

FIG. 6 illustrates a front view of aspects of an orientation support structure of a movable working platform system, in accordance with various embodiments, in accordance with various embodiments;

FIGS. 7-8 illustrate view of further aspects of an orientation support structure of a movable working platform system, in accordance with various embodiments;

FIGS. 9-10 illustrate views of aspects of a lifting mechanism of a movable working platform system, in accordance with various embodiments;

FIG. 11 illustrates features of a plurality of rollers of an orientation support structure, in accordance with various embodiments; and

FIG. 12 illustrates a method of operating a movable working platform system, in accordance with various embodiments.

### DETAILED DESCRIPTION

Operators in industrial and agricultural settings often must sit or stand at workstations. In various instances, workpieces pass by the workstations and the operator interacts with the workpiece from positions on platforms at the workstations. In one instance, a meat processing plant has a conveyor system that moves carcasses along a path. Along the path, different workstations are positioned where operators perform different tasks to prepare meat from the carcass for packaging. In various instances, other food preparation or different tasks occur from the workstations.

In many of these instances, different use cases, or in some instances, the processing of different items or types of carcasses, necessitates that the platforms be adjusted to be different elevations relative to a floor or the conveyor system. Conventional stands require significant disassembly and reassembly to change the elevation of the platform and correspondingly result in operating downtime as the stand is adjusted. Thus, a need exists for movable platform that can move to accommodate different heights or other dimensions, according to the disclosure herein.

Moreover, such environments necessitate frequent cleaning. As such, a need exists for a movable platform that omits closed channels typically associated with debris accumulation and bacterial growth.

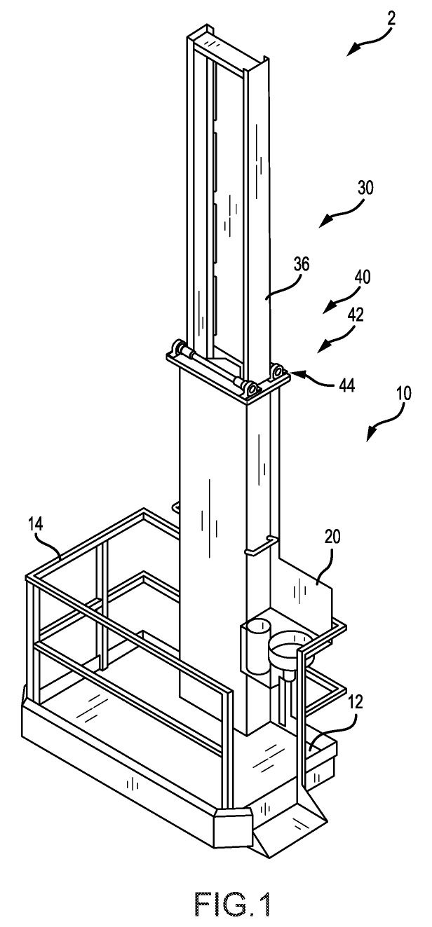

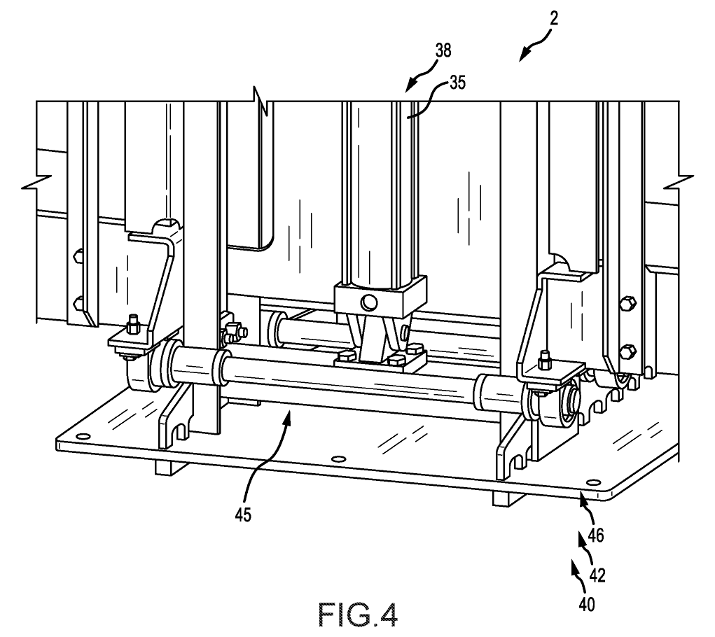

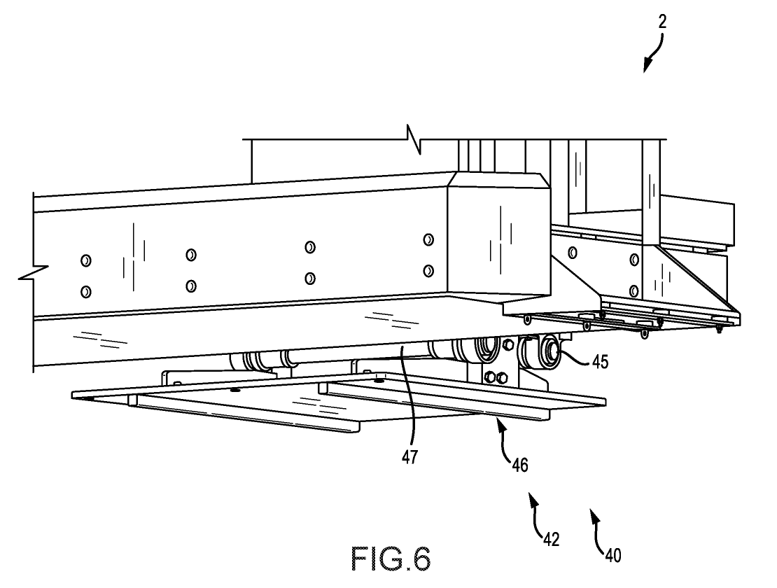

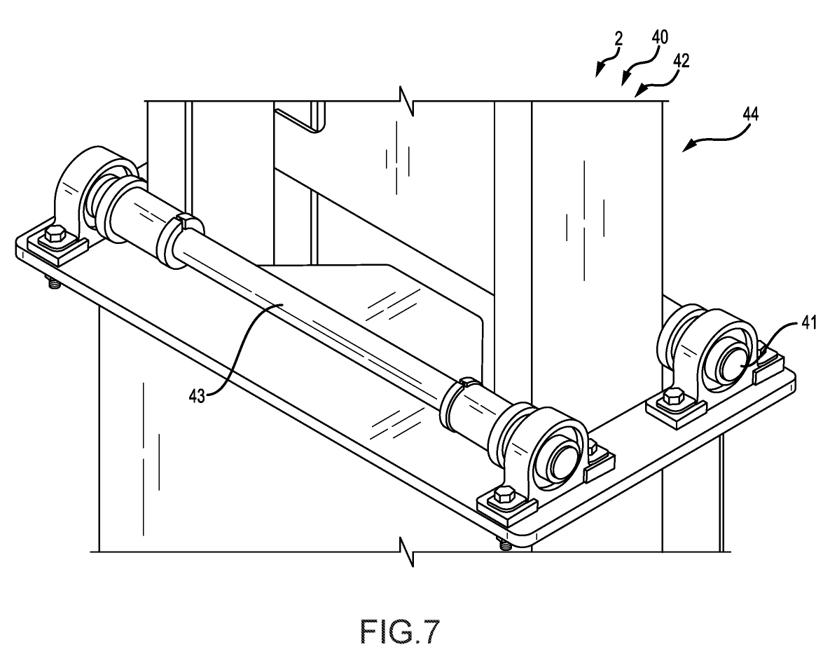

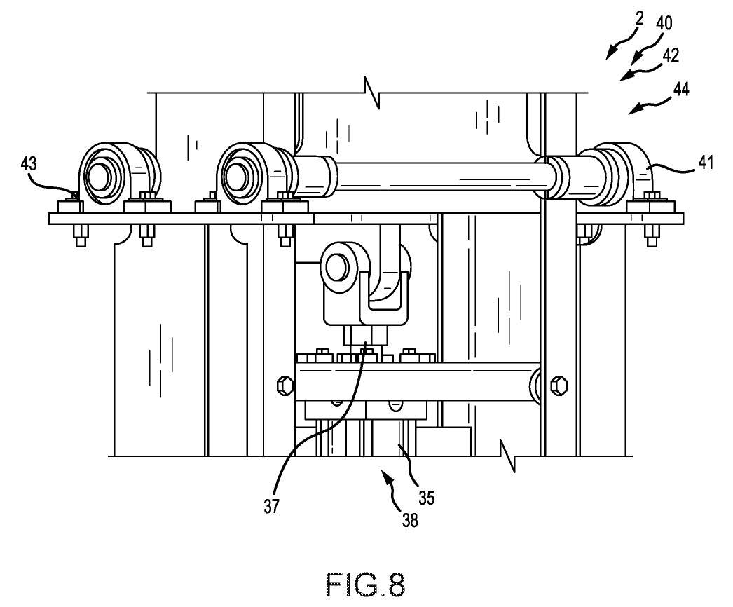

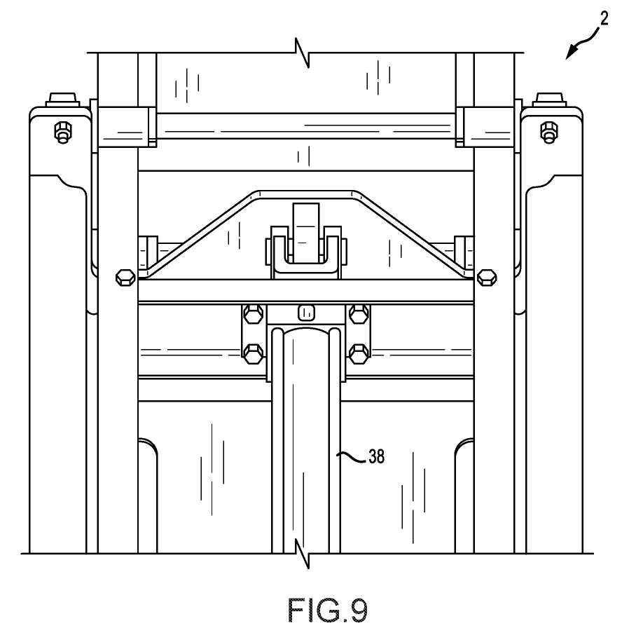

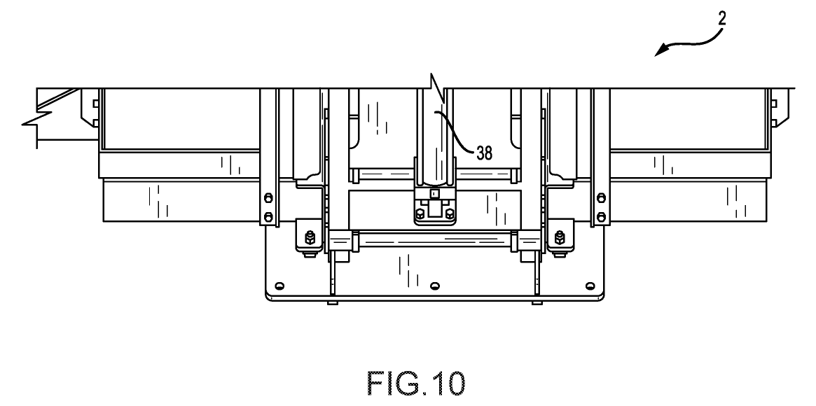

With reference to FIGS. 1-10, a movable working platform system 2 is provided. The movable working platform comprises an elevated structure that can be installed in a facility where workers perform tasks. For instance, the movable working platform system 2 may be adjacent to an automated conveyor line that moves workpieces among workstations. The movable working platform system 2 may be adjacent to a conveyor system that moves animal carcasses among workstations where the carcasses and/or meat form the carcasses is processed for human consumption. Different types of workpieces or carcasses having different dimensions are contemplated. Moreover, human operators may have different height and/or reach. The movable working platform system 2 may have various open channels throughout, to facilitate washing and ameliorate waste or bacteria accumulation.

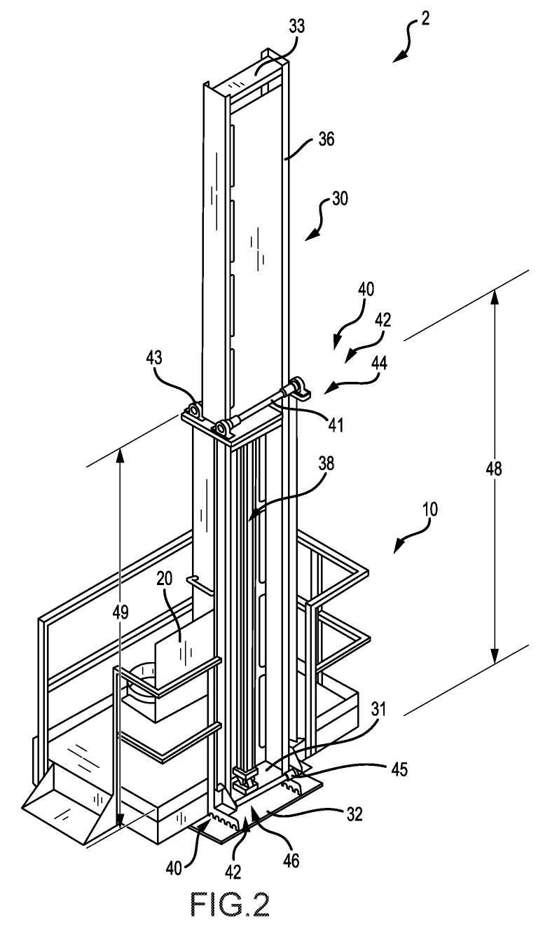

The movable working platform system 2 may have different components. Referring now to FIGS. 1 and 2, the movable working platform system 2 may have a movable platform 10. The movable platform 10 may have a standing surface 12 where an operator stands or sits on the standing surface 12. The operator may be protected from falling by a safety railing 14. The operator may access the working platform by steps. The movable working platform system 2 may have a workstation 20. The workstation 20 may be installed on or connected to the movable platform 10. For instance, the workstation 20 may be installed above the standing surface 12 of the movable platform 10, so that an operator who is standing on the standing surface 12 may use the workstation 20. In various embodiments, the workstation 20 is a cleaning station, such as a sink, or a knife washing apparatus, or a combination of a sink and knife washing apparatus.

The movable working platform system 2 may have a support subsystem 30. The support subsystem 30 may support the movable platform 10 at an elevation relative to a floor. For instance, the support subsystem 30 may have an attachment base 32. An attachment base 32 may be connectable to a floor or a concrete pad, or another structure. The attachment base 32 may affix the movable working platform system 2 in a fixed position relative to the floor or the concrete pad. Other aspects of the movable working platform system 2 may connect to the attachment base 32. In various embodiments, the attachment base 32 is a metal flange, though other configurations are possible.

The support subsystem 30 may have a guide structure 36. The guide structure 36 may extend away from the attachment base 32. For instance, the guide structure 36 may extend vertically (upwardly) from the attachment base 32. The guide structure 36 may provide guidance to the movable platform 10 as it moves, and may provide support to the movable platform 10 in at least one direction during use of the movable platform 10. The guide structure 36 may be open on one side, for instance, having a cross-section that generally has a U-shape, or a C-shape, or a three-sided-trapezoidal shape, to facilitate cleaning and washing and to ameliorate waste accumulation or bacterial growth. In various embodiments, the guide structure 36 is cantilevered from the attachment base 32. In various embodiments, the guide structure 36 attaches to the attachment base 32 at one end, such as a first end 31, and is not attached to anything at an opposite end, such as a second end 33. A first direction may be defined as a direction of movement of the movable platform 10. The first direction may be defined by the guide structure 36 and may be along at least one face of the guide structure 36, or along a primary central axis of the guide structure 36, or otherwise parallel to the guide structure 36. Thus, the first direction may be said to be parallel to the guide structure 36. The guide structure 36 may be a beam, an extrusion, an assembled member, or a combination of these or other features. The guide structure 36 may have a longer dimension that extends from the first end 31 to the second end 33. This longer dimension may be the first direction. The guide structure 36 may have a cross-section, as mentioned above. An outer profile of the cross-section may be an I-channel, or a C-channel, or a T-channel, or a box-like shape with an open portion to facilitate cleaning. In various embodiments, other features of the movable working platform system 2 ride against a surface of the guide structure 36 to constrain movement of the movable platform 10 to a desired subset of dimensions, such as upward and downward (e.g., vertically from the attachment base 32).

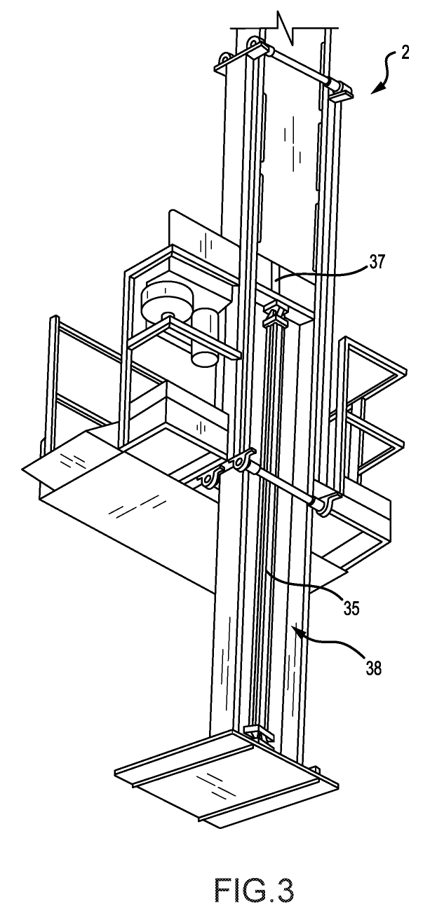

The support subsystem 30 may include a lifting mechanism 38. Attention is directed to the collection of FIGS. 2-4 and 8-10 for various illustrations of the lifting mechanism 38. The lifting mechanism 38 may be operable to move the movable platform 10 relative to the guide structure 36 of the support subsystem 30. The lifting mechanism 38 may be operable to move the movable platform 10 in a desired subset of dimensions, such as upward and downward. In various embodiments, the lifting mechanism 38 extends from at or adjacent to the attachment base 32 (FIG. 2) and upwardly relative to the guide structure 36. The lifting mechanism 38 may translate the movable platform 10 between locations bounded by the first end 31 and the second end 33 of the guide structure 36. In various embodiments, the lifting mechanism 38 is a hydraulic cylinder 35 (FIG. 3, 4, 8) that extends or retracts a shaft 37 (FIG. 3, 8) to which the movable platform 10 is connected. In other embodiments, the lifting mechanism 38 may be a cable and winch, or may be an apparatus attached to the movable platform 10 and movable with the movable platform 10, such as a rack and gear system with a motor to drive a gear to move the movable platform 10 along the rack. The lifting mechanism 38 may be a linear actuator, or any other device to move the movable platform 10 as desired.

Having introduced the support subsystem 30 (FIGS. 1-2), and the movable platform 10 (FIGS. 1-2) that supports the workstation 20 (FIGS. 1-2), attention is now directed to structures that facilitate guidance of the movable platform 10 along the guide structure 36 of the support subsystem 30. For instance, with reference now to FIGS. 1, 2, and 4-8, the movable working platform system 2 may include an orientation support structure 40.

In various embodiments, the orientation support structure 40 comprises fixtures, apparatuses, or other structures attached to the movable platform 10 to retain the movable platform 10 in position so that features of the movable working platform system 2 ride against a surface of the guide structure 36 to constrain movement of the movable platform 10 to a desired subset of dimensions, such as upward and downward. The orientation support structure 40 may comprise a plurality of rollers 42. The plurality of rollers 42 may ride against a surface of the guide structure 36 to constrain movement of the movable platform 10 to a desired subset of dimensions, such as upward and downward along the first direction parallel to a longer dimension of the guide structure 36, such as between a first end 31 (FIG. 2) and a second end 33 (FIG. 2) of the guide structure 36 as the lifting mechanism 38 operates to move the movable platform 10.

Referring to FIGS. 1-2 and 7-8, the plurality of rollers 42 may include an upper roller set 44. The upper roller set 44 may comprise rollers attached to the movable platform 10 at an end of the movable platform 10 further from the attachment base 32 (FIG. 2). Referring to FIGS. 2 and 4-6, the plurality of rollers 42 may include a lower roller set 46. The lower roller set 46 may comprise rollers attached to the movable platform 10 at an end of the movable platform 10 nearer to the attachment base 32 (FIG. 2). Thus the upper roller set 44 and the lower roller set 46 may be spaced apart along the guide structure 36 (FIG. 1 and 2) while attached to the movable platform 10. This spacing apart may cause the upper roller set 44 and the lower roller set 46 to resist twisting or other dimensional movement of the movable platform 10. This spacing apart may constrain movement of the movable platform 10 to a desired subset of dimensions, such as upward and downward along the first direction parallel to a longer dimension of the guide structure 36. This first direction may be between a first end 31 (FIG. 2) and a second end 33 (FIG. 2) of the guide structure 36 as the lifting mechanism 38 operates to move the movable platform 10.

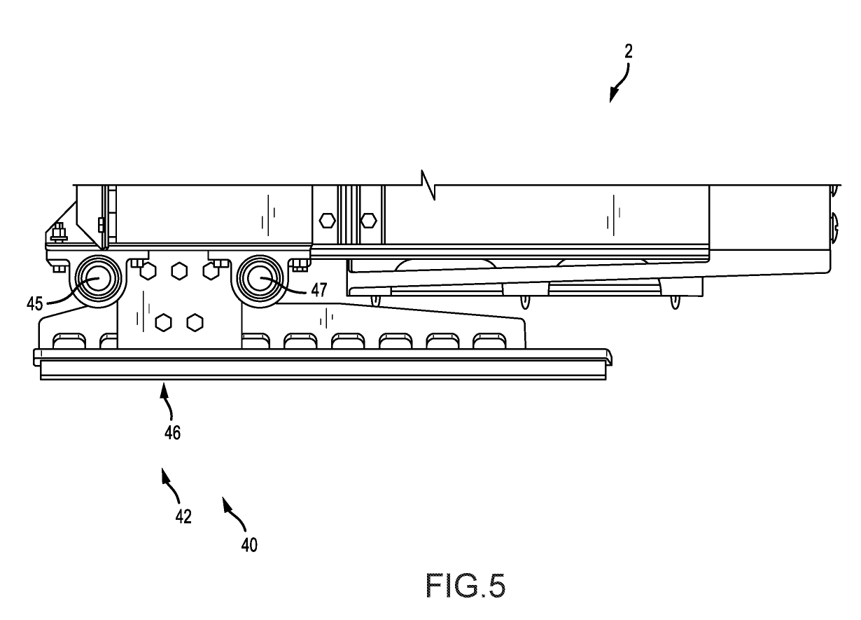

Each of the roller sets may have one or more roller therein. A roller comprises one or more feature contactable to the guide structure 36 to constrain movement relative to the guide structure 36 in some dimensions, while allowing or facilitating movement relative to the guide structure 36 in other dimensions. For instance, with reference to FIGS. 2, 7-8, and 11, an upper roller set 44 may include a first roller 41 and a second roller 43. The first roller 41 may be disposed toward one side of the guide structure 36, and the second roller 43 may be disposed toward an opposite side of the guide structure 36. The guide structure 36 may pass between the first roller 41 and the second roller 43 and may be captured between the first roller 41 and the second roller 43 of the upper roller set 44. Similarly, with reference to FIGS. 2, 4-6, a lower roller set 46 may include similar aspects. Referring also to FIGS. 5-6, and 11, the lower roller set 46 may include a third roller 45 (FIGS. 2, 4-6, and 11) and a fourth roller 47 (FIGS. 5-6, and 11). The third roller 45 may be disposed toward one side of the guide structure 36, such as a same side as the first roller 41 (FIGS. 2, 7-8, and 11). The fourth roller 47 may be disposed toward an opposite side of the guide structure 36, such as a same side as the second roller 43 (FIGS. 2, 7-8, and 11). Thus, the guide structure 36 may also pass between the third roller 45 and the fourth roller 47 and may be captured between the third roller 45 and the fourth roller 47 of the lower roller set 46.

The upper roller set 44 and the lower roller set 46 may be spaced apart. More specifically, the first roller 41 and the third roller 45 may be spaced apart by a first spacing distance 48. The second roller 43 and the fourth roller 47 may be spaced apart by a second spacing distance 49. The first spacing distance 48 and the second spacing distance 49 may be a same distance. The first spacing distance 48 and the second spacing distance 49 may be a different distance. The upper roller set 44 may include rollers spaced around the guide structure 36 in a plane oriented so that the first direction passes through the plane defined by the rollers. The lower roller set 46 may include rollers spaced around the guide structure 36 in a plane oriented so that the first direction passes through the plane defined by the plurality of rollers.

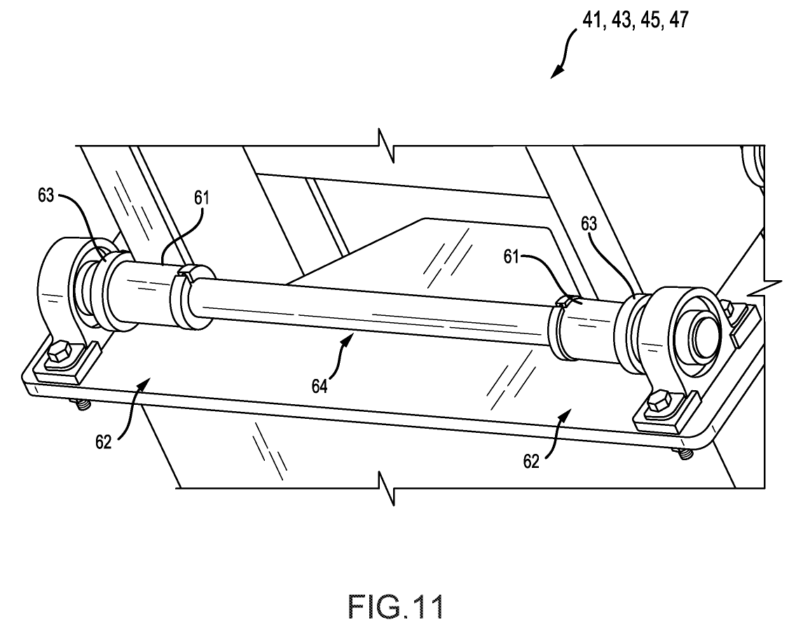

Each of the aforementioned rollers may also have aspects, for instance, a roller may have multiple rolling and/or contacting members that contact the guide structure 36. For instance, referring to FIG. 11, an example roller is shown. This roller may be an example of one or more of the first roller 41, the second roller 43, the third roller 45, and the fourth roller 47. The roller may include one or more contact member 62. For instance, the roller may include two contact members 62 spaced apart by a connecting shaft 64. the contact members 62 may roll in unison via connection by the connecting shaft 64. The contact members 62 may roll separately and be spaced apart via the connection of the connecting shaft 64. In other embodiments, the contact members 62 may roll separately and may travel along a length of the connecting shaft 64, such as to accommodate changes in a surface (such as a surface of guide structure 36 (FIGS. 1, 2)) against which the contact members are rolling.

Each contact member 62 may have various features. For instance, a contact member 62 may be structured to roll against an edge of the guide structure 36. The contact member 62 may have a riding cylinder 61 comprising a cylindrical face to ride against a side of the guide structure 36. The contact member 62 may have a guidance shoulder 63. The guidance shoulder 63 may be an annulus integrally formed with or joined to the riding cylinder 61 and having a greater outer circumference than the riding cylinder 61. The guidance shoulder 63 may contact a side of the guide structure 36 that extends at an angle from the surface that is contacted by the riding cylinder 61. The transition from the riding cylinder 61 to the guidance shoulder 63 may correspond to this angle. For instance, for a right angle side of the guide structure 36, the guidance shoulder 63 may be an annulus having a greater outer circumference than the riding cylinder 61 and a right angle edge may exist at a transition from the guidance shoulder 63 to the riding cylinder 61. This right angle edge may abut a corner (e.g., a transition between two different sides) of the guide structure 36. In this manner, the roller having two spaced apart contact members 62, may constrain motion of the orientation support structure 40 (FIGS. 1, 2, 4-8) (and thus the movable platform 10) in two perpendicular dimensions of movement.

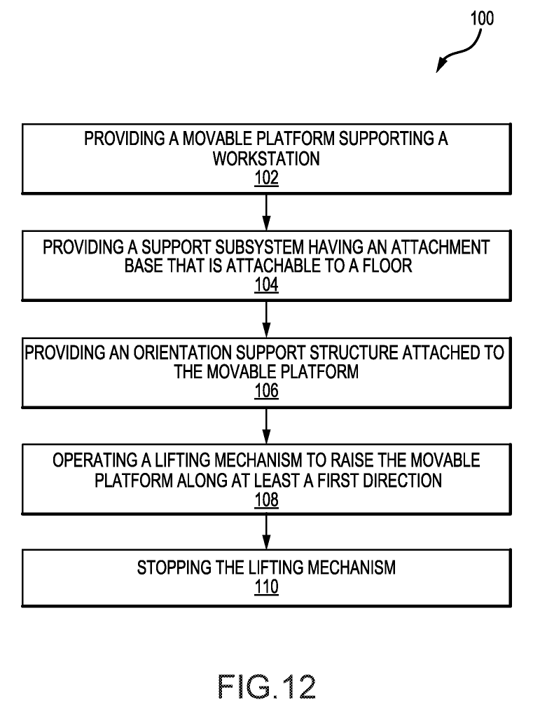

Referring now to FIG. 12, a method 100 is provided. The method may be a method of operating a movable working platform system. In various instances, the method may include providing a movable platform supporting a workstation (block 102). The movable platform may be movable in at least a first direction. The method may include providing a support subsystem having an attachment base that is attachable to a floor (block 104). The support subsystem may include a guide structure extending in the first direction away from the attachment base. The support subsystem may include a lifting mechanism attached to at least one of the attachment base and the guide structure. The lifting mechanism selectively raises and lowers the movable platform along at least the first direction to change a position of the workstation along the guide structure extending in the first direction. The method may include providing an orientation support structure attached to the movable platform (block 106). The orientation support structure may include a plurality of rollers spaced around the guide structure in a plane oriented so that the first direction passes through the plane defined by the plurality of rollers. The plurality of rollers are contactable to the guide structure to retain the movable platform in movable connection to the guide structure. The method may include operating the lifting mechanism to raise the movable platform along at least the first direction (block 108). This may progressively raise the workstation to a progressively higher position along the guide structure. The method may include stopping the lifting mechanism to cease raising the movable platform (block 110). The ceasing may be at a desired elevation relative to the floor underlying the guide structure.

Referring now to the collection of FIGS. 1-12, various example embodiments are instructive. For instance, a movable working platform system 2 is provided. The system may include a movable platform 10 supporting a workstation 20. The movable platform 10 is movable in at least a first direction. The system may include a support subsystem 30. The support subsystem 30 may have various aspects. For instance, the support subsystem 30 may have an attachment base 32 that is attachable to a floor. The support subsystem 30 may include a guide structure 36 extending in the first direction away from the attachment base 32. The support subsystem 30 may include a lifting mechanism 38 attached to at least one of the attachment base 32 and the guide structure 36. The lifting mechanism 38 selectively raises and lowers the movable platform 10 along at least the first direction to change a position of the workstation 20 along the guide structure 36 extending in the first direction. The movable working platform system 2 may include an orientation support structure 40. The orientation support structure 40 may be attached to the movable platform 10. The orientation support structure 40 may include a plurality of rollers 42 spaced around the guide structure 36 in a plane oriented so that the first direction passes through the plane defined by the plurality of rollers 42. The plurality of rollers 42 are contactable to the guide structure 36 to retain the movable platform 10 in movable connection to the guide structure 36.

In various embodiments, one or more further aspects may also be included. For instance, the plurality of rollers 42 may include a first roller 41 and a second roller 43 disposed on opposite sides of the guide structure 36.

The plurality of rollers 42 may include a first roller 41 and a second roller 43 disposed on opposite sides of the guide structure 36 as well as a third roller 45 and a fourth roller 47 disposed on opposite sides of the guide structure 36. The third roller 45 is disposed on a same side of the guide structure 36 as the first roller 41. The fourth roller 47 is disposed on a same side of the guide structure 36 as the second roller 43. The first roller 41 and the third roller 45 are spaced apart a first spacing distance 48 in the first direction. The second roller 43 and the fourth roller 47 are spaced apart a second spacing distance 49 in the first direction. In various instances, the first spacing distance 48 and the second spacing distance 49 are a same distance.

In various instances, the guide structure 36 has a first end 31 and a second end 33 opposite the first end 31. The first end 31 is attached to the attachment base 32. The second end 33 cantilevers away from the attachment base 32. In various embodiments, the second end 33 of the guide structure 36 is not attached to anything. In various embodiments, the first direction is a vertical direction.

The lifting mechanism 38 may have different features. For example, the lifting mechanism 38 may have a hydraulic cylinder 35. The lifting mechanism 38 may have a shaft 37. The hydraulic cylinder 35 may selectably extend the shaft 37. The shaft 37 may be attached to the movable platform 10 to move the movable platform 10 in the first direction. The movable platform 10 may have a standing surface 12 for standing on by a worker while operating the workstation 20.

A further example of a movable working platform system 2 is provided. The system may include a movable platform 10. The system may include a guide structure 36. The system may include a lifting mechanism 38. The system may include a plurality of rollers 42. The movable platform 10 may be movable in at least a first direction along a guide structure 36. The guide structure 36 may extend vertically from a floor in the first direction. The system may include a lifting mechanism 38 attached to the movable platform 10 to lift the movable platform 10 in the first direction along the guide structure 36. The system may include a plurality of rollers 42 attached to the movable platform 10 and spaced around at least a portion of the guide structure 36 to retain the movable platform 10 in movable attachment to the guide structure 36.

Other features may be included. For instance, the plurality of rollers 42 may include a first roller 41 and a second roller 43 disposed on opposite sides of the guide structure 36. The plurality of rollers 42 may include a first roller 41 and a second roller 43 disposed on opposite sides of the guide structure 36. The plurality of rollers 42 may include a third roller 45 and a fourth roller 47 disposed on opposite sides of the guide structure 36. The third roller 45 is disposed on a same side of the guide structure 36 as the first roller 41. The fourth roller 47 is disposed on a same side of the guide structure 36 as the second roller 43. The first roller 41 and the third roller 45 are spaced apart a first spacing distance 48 in the first direction. The second roller 43 and the fourth roller 47 are spaced apart a second spacing distance 49 in the first direction.

The first spacing distance 48 and the second spacing distance 49 may be a different distance. The first spacing distance 48 and the second spacing distance 49 may be a same distance. The guide structure 36 has a first end 31 and a second end 33 opposite the first end 31. The first end 31 is attached to an attachment base 32 attachable to the floor. The second end 33 cantilevers away from the attachment base 32. In various embodiments, second end 33 of the guide structure 36 is not attached to anything.

The lifting mechanism 38 may have a hydraulic cylinder 35 to selectably extend a shaft 37 that is attached to the movable platform 10 to move the movable platform 10 in the first direction. The movable platform 10 may be a standing surface 12 for standing on by a worker while operating the workstation 20. The workstation 20 may be a sink and knife washing station. The movable platform 10 may include a safety railing 14 to ameliorate fall risk of the worker while operating the workstation 20 with the movable platform 10 extended in the first direction away from the floor.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A movable working platform system comprising:
a movable platform supporting a workstation, the movable platform movably in at least a first direction;
a support subsystem having an attachment base that is attachable to a floor and further comprising:
a guide structure extending in the first direction away from the attachment base;
a lifting mechanism attached to at least one of the attachment base and the guide structure,
wherein the lifting mechanism selectively raises and lowers the movable platform along at least the first direction to change a position of the workstation along the guide structure extending in the first direction; and
an orientation support structure attached to the movable platform and comprising:
a plurality of rollers spaced around the guide structure in a plane oriented so that the first direction passes through the plane defined by the plurality of rollers,
wherein the plurality of rollers are contactable to the guide structure to retain the movable platform in movable connection to the guide structure.

2. The movable working platform system according to claim 1, wherein the plurality of rollers comprises a first roller and a second roller disposed on opposite sides of the guide structure.

3. The movable working platform system according to claim 1, wherein the plurality of rollers comprises:
a first roller and a second roller disposed on opposite sides of the guide structure,
a third roller and a fourth roller disposed on opposite sides of the guide structure,
wherein the third roller is disposed on a same side of the guide structure as the first roller,
wherein the fourth roller is disposed on a same side of the guide structure as the second roller,
wherein the first roller and the third roller are spaced apart a first spacing distance in the first direction, and
wherein the second roller and the fourth roller are spaced apart a second spacing distance in the first direction.

4. The movable working platform system according to claim 3, wherein the first spacing distance and the second spacing distance are a same distance.

5. The movable working platform system according to claim 1,
wherein the guide structure has a first end and a second end opposite the first end,
wherein the first end is attached to the attachment base, and
wherein the second end cantilevers away from the attachment base.

6. The movable working platform system according to claim 5, wherein the second end of the guide structure is not attached to anything.

7. The movable working platform system according to claim 1, wherein the first direction is a vertical direction.

8. The movable working platform system according to claim 1, wherein the lifting mechanism comprises a hydraulic cylinder to selectably extend a shaft that is attached to the movable platform to move the movable platform in the first direction.

9. The movable working platform system according to claim 1, wherein the movable platform comprises a standing surface for standing on by a worker while operating the workstation.

10. A movable working platform system comprising:
a movable platform movably in at least a first direction along a guide structure,
the guide structure extending vertically from a floor in the first direction;
a lifting mechanism attached to the movable platform to lift the movable platform in the first direction along the guide structure; and
a plurality of rollers attached to the movable platform and spaced around at least a portion of the guide structure to retain the movable platform in movable attachment to the guide structure.

11. The movable working platform system according to claim 10, wherein the plurality of rollers comprises a first roller and a second roller disposed on opposite sides of the guide structure.

12. The movable working platform system according to claim 10, wherein the plurality of rollers comprises:
a first roller and a second roller disposed on opposite sides of the guide structure,
a third roller and a fourth roller disposed on opposite sides of the guide structure,
wherein the third roller is disposed on a same side of the guide structure as the first roller,
wherein the fourth roller is disposed on a same side of the guide structure as the second roller,
wherein the first roller and the third roller are spaced apart a first spacing distance in the first direction, and
wherein the second roller and the fourth roller are spaced apart a second spacing distance in the first direction.

13. The movable working platform system according to claim 12, wherein the first spacing distance and the second spacing distance are a same distance.

14. The movable working platform system according to claim 12,
wherein the guide structure has a first end and a second end opposite the first end,
wherein the first end is attached to an attachment base attachable to the floor, and
wherein the second end cantilevers away from the attachment base.

15. The movable working platform system according to claim 14, wherein the second end of the guide structure is not attached to anything.

16. The movable working platform system according to claim 10, wherein the lifting mechanism comprises a hydraulic cylinder to selectably extend a shaft that is attached to the movable platform to move the movable platform in the first direction.

17. The movable working platform system according to claim 1, wherein the movable platform comprises a standing surface for standing on by a worker while operating the workstation.

18. The movable working platform system according to claim 17, wherein the workstation is a sink and knife washing station.

19. The movable working platform system according to claim 17, wherein the movable platform further comprises a safety railing to ameliorate fall risk of the worker while operating the workstation with the movable platform extended in the first direction away from the floor.

20. A method of operating a movable working platform system, the method comprising:
providing a movable platform supporting a workstation, the movable platform movably in at least a first direction;
providing a support subsystem having an attachment base that is attachable to a floor and further comprising:
a guide structure extending in the first direction away from the attachment base;
a lifting mechanism attached to at least one of the attachment base and the guide structure,
wherein the lifting mechanism selectively raises and lowers the movable platform along at least the first direction to change a position of the workstation along the guide structure extending in the first direction;
providing an orientation support structure attached to the movable platform and comprising:
a plurality of rollers spaced around the guide structure in a plane oriented so that the first direction passes through the plane defined by the plurality of rollers,
wherein the plurality of rollers are contactable to the guide structure to retain the movable platform in movable connection to the guide structure;
operating the lifting mechanism to raise the movable platform along at least the first direction and progressively raise the workstation to a progressively higher position along the guide structure; and
stopping the lifting mechanism to cease raising the movable platform at a desired elevation relative to the floor underlying the guide structure.
